(19) United States
(12) Patent Application Publication
(10) Pub. No.: US 2014/0267496 A1
(43) Pub. Date: Sep. 18, 2014

(54) RECORDING DEVICE

(71) Applicant: SEIKO EPSON CORPORATION, Tokyo (JP)

(72) Inventor: Masaki KOBAYASHI, Matsumoto-shi (JP)

(73) Assignee: SEIKO EPSON CORPORATION, Tokyo (JP)

(21) Appl. No.: 14/211,052

(22) Filed: Mar. 14, 2014

(30) Foreign Application Priority Data
Mar. 18, 2013 (JP) 2013-054688

(51) Int. Cl. B41J 25/308; B41J 25/00

(52) U.S. Cl. CPC B41J 25/308; B41J 25/001
USPC 347/37

(57) ABSTRACT

A recording device includes: a supporting stage configured to support a recording medium; a recording unit facing the recording medium; a Y-axis moving section configured to move the recording unit in a Y-axis direction; and an upward/downward moving section configured to move the recording unit in an X-axis direction such that the recording unit moves toward and away from the supporting stage. The upward/downward moving section includes an upward/downward drive mechanism configured to move the recording unit toward and away from the supporting stage and two upward/downward guide mechanisms configured to guide the movement of the Y-axis moving section in the Z-axis direction of the recording unit. The upward/downward drive mechanism and the two upward/downward guide mechanisms are arranged side by side in the Y-axis direction.

### BACKGROUND

1. Technical Field

The present invention relates to a so-called flatbed recording device in which a recording unit moves relative to a recording medium on a stage in order to perform recording.

2. Related Art

An existing recording device of this type includes a stage supporting a recording medium, a recording unit facing the stage, an X bar (an X-axis supporting member) supporting the recording unit such that the recording unit can reciprocate along an X axis (i.e., in a main scanning direction), an X-axis moving mechanism causing the recording unit to reciprocate along the X axis by means of a timing belt driven by a servomotor, a pair of struts supporting both ends of the X bar, and a Y-axis moving mechanism coupled to the struts and causing the recording unit to move along a Y axis (i.e., in a sub-scanning direction) via the struts and the X bar (see JP-A-2012-210781). It should be noted that the X-axis and the Y-axis are reversed in the description of JP-A-2012-210781.

### SUMMARY

In order to cope with recording media having various thicknesses, such a recording device may have a moving section that moves a recording unit toward and away from a recording medium. For example, the moving section supports the X bar and moves the recording unit toward and away from a recording medium via the X bar. However, the moving section included in the existing recording device described above can cause a problem that the recording unit vibrates along the Y-axis around the moving section under the influence of an inertial force when the recording unit intermittently moves in the Y-axis direction. Consequently, as a result of recording by the recording unit with intermittent movement of the recording unit along the Y-axis, vibration occurs in this printing due to movement and stopping of the recording unit. This vibration significantly reduces the recording precision of a print head. Stopping movement of the recording unit to prevent a decrease in recording precision caused by the vibration until the vibration is attenuated or stopped, and then starting recording of the print head has also been considered. In this case, a standby time until attenuation or stopping of the vibration is needed, which disadvantageously decreases a throughput (i.e., capacity per unit time).

An advantage of some aspects of the invention is to provide a recording device capable of reducing vibration caused by movement and stop of a recording unit with a simple configuration.

According to an aspect of the invention, a recording device includes: a stage configured to support a recording medium; a recording unit configured to perform recording on the supported recording medium; a first moving section configured to move the recording unit in a first direction; and a second moving section configured to move the recording unit in a second direction intersecting the first direction such that the recording unit moves toward and away from the stage, wherein the second moving section includes a drive mechanism configured to move the recording unit toward and away from the stage, and a guide mechanism configured to guide the movement of the recording unit in the second direction, and the drive mechanism and the guide mechanism are disposed side by side in the first direction.

In this configuration, the drive mechanism and the guide mechanism in the second moving section are disposed side by side, thereby enhancing rigidity on the first direction of the second moving section against an inertial force caused by movement and stop (especially intermittent feeding) in the first direction. Thus, vibration in the first direction occurring when the recording unit moves or stops in the first direction can be reduced with a simple configuration. As a result, the recording precision of the recording unit can be enhanced, and a throughput (i.e., capacity per unit time) can be increased.

In this case, it is preferable that the guide mechanism includes a linear guide mechanism including a guide rail and a slider that is movable relative to the guide rail in the second direction, the drive mechanism includes a fixed member and a movable member that is movable relative to the fixed member, and at least while the recording unit performs recording on the recording medium, a contact position at which the slider is in contact with the guide rail in the second direction is different from a contact position at which the fixed member is in contact with the movable member in the second direction.

During vibration of the recording unit, the second moving section sways around the contact position (i.e., the engagement position) at which the fixed member is in contact (engaged) with the movable member. At this time, if the contact position between the fixed member and the movable member coincided with the contact position between the slider and the guide rail in the second direction, the second moving section would rotate about the second direction when viewed from the slider, and thus, a force that reduces sway would fails to act on the slider.

On the other hand, in the configuration in which the contact position between the fixed member and the movable member shifts from the contact position between the slider and the guide rail at least while the recording unit performs recording, the second moving section rotates obliquely when viewed from the slider, and thus, a force that reduces sway can act on each slider. That is, a rotary force is received by the guide mechanism (and the frame supporting the guide mechanism) (i.e., the function of bracing is obtained). In this manner, vibration in the first direction occurring when the recording unit moves or stops in the first direction can be further reduced.

The guide mechanism preferably has a first guide mechanism located forward of the drive mechanism in a recording direction in which the recording unit performs recording and which is either a forward direction or a backward direction of the recording unit in the first direction.

In this configuration, since a front portion in the recording direction is firmly fixed, it is possible to reduce initial sway caused by an inertial force when movement of the recording unit in the recording direction is stopped. Thus, vibration can be reduced as a whole, and vibration of the recording unit in the first direction occurring when the recording unit moves or stops in the first direction can be further reduced.

In addition, the guide mechanism preferably includes a second guide mechanism located backward of the drive mechanism in the recording direction.

In this configuration, the guide mechanisms are disposed both forward and backward of the drive mechanism serving as a center of vibration, and thus, vibration in the recording direction caused by movement in the recording direction can be further reduced.

In this case, at least while the recording unit performs recording on the recording medium, a contact position in the first guide mechanism at which the slider is in contact with the guide rail in the second direction is preferably located farther from the drive mechanism than a contact position in the second guide mechanism at which the slider is in contact with the guide rail in the second direction is.

In addition, the first guide mechanism preferably includes a larger number of sliders than the second guide mechanism does.

Further, a distance between the first guide mechanism and the drive mechanism in the first direction is preferably smaller than a distance between the second guide mechanism and the drive mechanism in the first direction.

In these configurations, since a front portion in the recording direction is firmly fixed, it is possible to reduce initial sway caused by an inertial force when movement of the recording unit in the recording direction is stopped. Thus, vibration can be reduced as a whole, and vibration of the recording unit in the first direction occurring when the recording unit moves or stops in the first direction can be further reduced.

### BRIEF DESCRIPTION OF THE DRAWINGS

The invention will be described with reference to the accompanying drawings, wherein like numbers reference like elements.

FIG. 1 is a perspective view illustrating an appearance of a recording device according to an embodiment.

FIG. 2A is a plan view of the recording device.

FIG. 2B is a front view of the recording device.

FIG. 2C is a side view of the recording device.

FIG. 3 is a cross-sectional view taken along line III-III and illustrating a supporting stage and a portion around a Y-axis moving section.

FIG. 4 is a perspective view illustrating a recording processor where a device cover is not shown.

FIG. 5 is a front view illustrating the recording processor where a device cover is not shown.

FIG. 6 is an inner side view illustrating a side frame and a portion around an upward/downward moving section incorporated in the side frame.

FIG. 7 illustrates a positional relationship between an upward/downward guide mechanism and an upward/downward drive mechanism.

FIG. 8 is a control block diagram illustrating a control configuration of the recording device.

### DESCRIPTION OF EXEMPLARY EMBODIMENTS

A recording device according to an embodiment of the invention will be described with reference to the attached drawings. The recording device ejects ultraviolet (UV) curable ink with an ink jet system in order to record a desired image on a recording medium. The recording device of this embodiment is a so-called flatbed recording device that performs recording with a print head that is moved relative to a recording medium supported on a supporting stage. Examples of the recording medium include recording media having various thicknesses such as cardboard, wood, tiles, plastic boards, styrene boards, and corrugated boards. As shown in the drawings, the following description is based on the definitions of an X-axis (lateral) direction, a Y-axis (longitudinal) direction, and a Z-axis (vertical) direction. The back side in FIG. 1 will be hereinafter referred to as one side in the Y-axis direction, and the front side in FIG. 1 will be hereinafter referred to as the other side in the Y-axis direction.

As illustrated in FIG. 1 and FIGS. 2A to 2C, a recording device 1 is supported by four legs 10, and includes a supporting stage (a stage) 11 supporting a recording medium A, a recording processor 12 including a recording unit 31 facing the supported recording medium A, an Y-axis moving section (a first moving section) 13 (see FIG. 3) supporting the recording processor 12 and moving the recording processor 12 relative to the supporting stage 11 in the Y-axis direction (a first direction), and a control section 14 (see FIG. 8) for controlling these components. The recording processor 12 spans the supporting stage 11 in the X-axis direction. On the other hand, the Y-axis moving section 13 is disposed on the back surface (the surface on one side opposite to the recording processor 12) of the supporting stage 11, and supports the recording processor 12 such that the recording processor 12 can move on the back surface of the supporting stage 11, which will be described in detail below.

Referring now to FIGS. 2A to 2C and FIG. 3, the supporting stage 11 will be described. FIG. 3 is a cross-sectional view taken along line III-III and illustrating the supporting stage 11 and a portion around the Y-axis moving section 13 when viewed from the one side in the Y-axis direction. As illustrated in FIGS. 2A to 2C and FIG. 3, the supporting stage 11 includes a pair of left and right beam-like structural members 21 extending in the Y-axis direction, a plurality of supporting members 22 located between the pair of structural members 21, and a suction table 23 which is supported by the pair of structural members 21 and the supporting members 22 and to which the recording medium A is attached by suction. An end of each of the structural members 21 is connected to a corresponding one of the legs 10 by, for example, welding. An operation panel 24 is located at the other end in the Y-axis direction of the supporting stage 11. A large door 24a is provided in a right half portion of the operation panel 24. To perform manual maintenance on the recording processor 12, the recording processor 12 is moved to the front side (i.e., the other side in the Y-axis direction), the door 24a is opened, and maintenance of the recording processor 12 is performed through the door 24a.

The suction table 23 includes a table body 26 having a large number of suction holes (not shown) and a suction chamber 27 located below the table body 26. The suction chamber 27 is connected to vacuum suctioning equipment (not shown) via, for example, pipes or ducts. That is, the recording medium A placed on the table body 26 is sucked by driving the vacuum suctioning equipment, thereby allowing the recording medium A to be held on the table body 26.

The structural members 21 are made of mold materials (square pipes) that are rectangular in cross section, and individually connected to the legs 10 at both ends in the Y-axis direction. The upper surfaces of the structural members 21 are table attachment surfaces to which the table body 26 is attached. Rail attachment members 25a and 25b to which Y-axis guide rails 91, which will be described later, are attached are fixed to the lower surfaces of the structural members 21.

As illustrated in FIGS. 4 and 5, the recording processor 12 faces the supported recording medium A, and includes a recording unit 31 for recording on the recording medium A, an X-axis moving section 32 supporting the recording unit 31 and moving the recording unit 31 in the X-axis direction, a lateral frame 33 supporting the X-axis moving section 32, a pair of left and right side frames 34 supporting the lateral frame 33 on both sides in the X-axis direction, a coupling frame 35 coupling bases of the side frames 34, and a device cover (see FIG. 1) 36 covering these components. The lateral frame 33 extends across the supporting stage 11 in the X-axis direction. Each of the side frames 34 extends to a portion under the supporting stage 11. The coupling frame 35 is coupled to the bottom ends of the pair of side frames 34 below the table body 26 of the supporting stage 11.

The lateral frame 33, the pair of side frames 34, and the coupling frame 35 constitute a rectangular frame section thereof spans the supporting stage 11 and surrounds the supporting stage 11.

The recording processor 12 is located at the rear (at the one side) in the Y-axis direction of the lateral frame 33, and includes a tube holder 41 for holding an ink tube and a cable, a tank unit (see FIG. 1) 42 having ink tanks of individual colors, and a maintenance unit 43 for maintenance and recovery of the function of print heads 52.

The recording unit 31 including a carriage 51 including two print heads 52 and a pair of UV irradiation units 54 located at both sides in the X-axis direction of the carriage 51. Each of the UV irradiation units 54 includes a plurality of UV irradiation LEDs 54a (see FIG. 8), and cures (fixes) UV curable ink ejected from the print heads 52 with UV irradiation from the UV irradiation LEDs 54a.

The print heads 52 are ink jet heads that are driven by a piezoelectric device to eject ink, and includes a plurality of nozzle rows (not shown) associated with individual colors and extending in the Y-axis direction. That is, the print heads 52 are configured to eject UV curable ink of a plurality of colors. The nozzle surfaces of the print heads 52 face the recording medium A. In this embodiment, ink jet heads of a piezoelectric type are used. However, the invention is not limited to this type, and ink jet heads of, for example, a thermal type or an electrostatic type may be used. The invention is not limited to these on-demand ink jet heads, either, and continuous ink jet heads may be used.

The X-axis moving section 32 is supported on the lateral frame 33, and includes a pair of upper and lower guide shafts 61 supporting the recording unit 31 such that the recording unit 31 can reciprocate in the X-axis direction, and an X-axis driving mechanism 62 for driving the recording unit 31 along the pair of guide shafts 61.

The X-axis driving mechanism 62 includes a timing belt 63 extending in the X-axis direction along the pair of guide shafts 61, a drive pulley 66 and a driven pulley 64 spanned by the timing belt 63, a coupling fixing portion (not shown) coupling the timing belt 63 and the recording unit 31, and a carriage motor 65 for driving the drive pulley 66. In the X-axis moving section 32, the carriage motor 65 is rotated reversibly so that the recording unit 31 reciprocates on the pair of guide shafts 61 in the X-axis direction via the timing belt 63. With this reciprocation, the print heads 52 are driven to eject ink, thereby performing recording.

As illustrated in FIGS. 3 to 5, the coupling frame 35 is disposed at the back surface of the supporting stage 11, and overlaps a region in which the recording unit 31 moves in the X- and Y-axis directions. The coupling frame 35 includes a plurality of rod-like frames 81 spanning base portions of the side frames 34, a plate-like frame 82 fixed to the rod-like frames 81 at the lower surface, a pair of vertical frames 85 coupling the rod-like frames 81 at both ends in the X-axis direction, a plurality of lateral frames 83 fixed on the vertical frames 85 between the rod-like frames 81 and extending parallel to the rod-like frames 81, and a mounting plate 84 which spans the rod-like frames 81 at the upper surface and on which the drive motor 88 of the Y-axis moving section 13 is mounted.

The Y-axis moving section 13 includes a pair of Y-axis guide mechanisms 86 located at the left and right sides on the back surface of the supporting stage 11 and causing the recording processor 12 to slide relative to the supporting stage 11 in the Y-axis direction, a Y-axis moving mechanism 87 located at the middle on the back surface the supporting stage 11 and causing the recording processor 12 to move relative to the supporting stage 11 in the Y-axis direction, and a drive motor 88 for driving the Y-axis moving mechanism 87. The Y-axis moving mechanism 87 is disposed between the pair of Y-axis guide mechanisms 86 in the X-axis direction.

The Y-axis guide mechanism 86 is an LM Guide (registered trademark) mechanism. The LM Guide mechanism 86 includes Y-axis guide rails 91 fixed to the rail attachment members 25a and 25b of the structural members 21 and extending in the Y-axis direction and Y-axis sliders 92 fixed to the plate-like frame 82 of the coupling frame 35 and slideably moving on the Y-axis guide rails 91.

The Y-axis moving mechanism 87 is a ball screw mechanism. The Y-axis moving mechanism 87 includes a Y-axis threaded shaft 96 fixed to the supporting stage 11 and extending in the Y-axis direction and a Y-axis nut 98 fixed to the plate-like frame 82 of the coupling frame 35 via a supporting member 97 such that the Y-axis nut 98 can rotate, and screwed onto the Y-axis threaded shaft 96. In the Y-axis moving section 13, driving (rotation) of the Y-axis nut 98 by the drive motor 88 causes the Y-axis nut 98 to move in the Y-axis direction relative to the Y-axis threaded shaft 96 along a thread groove formed on the Y-axis threaded shaft 96. In this manner, the recording processor 12 is moved along the Y-axis guide mechanism 86 in the Y-axis direction by means of the Y-axis moving section 13. Specifically, the Y-axis moving section 13 moves the recording unit 31 in the Y-axis direction via an upward/downward moving section 69 and an X-axis moving section 32. In this embodiment, the Y-axis threaded shaft 96 is fixed and the Y-axis nut 98 is rotated. Alternatively, the Y-axis nut 98 may be fixed with the Y-axis threaded shaft 96 being rotated. Further, both of the Y-axis nut 98 and the Y-axis threaded shaft 96 may be rotated such that the Y-axis nut 98 is moved relative to the Y-axis threaded shaft 96 in the Y-axis direction.

Referring now to FIGS. 4 to 6, the side frames 34 and the upward/downward moving section 69 included therein will be described. As illustrated in FIGS. 4 to 6, each of the side frames 34 includes an upward/downward moving section (a second moving section) 69 causing the recording unit 31 to move vertically (i.e., in the Z-axis direction: a second direction) and to move toward and away from the supporting stage 11. Specifically, each of the side frames 34 includes a box-shape frame body 68 supporting the lateral frame 33 and an upward/downward moving section 69 coupling the frame body 68 and the coupling frame 35 together and lifting and lowering (moving upward and downward) the frame body 68.

The vertical movement of the frame body 68 by means of the upward/downward moving section 69 vertically moves the recording unit 31 via the frame body 68, the lateral frame 33, and the X-axis moving section 32. In this manner, the recording unit 31 moves toward or away from the supporting stage 11 and the recording medium A supported on the supporting stage 11 (gap adjustment).

The frame body 68 supports the lateral frame 33. The frame body 68 includes fixing plate portions 68a at the sides facing the recording device 1 (i.e., facing the supporting stage 11), and moving sides of the upward/downward moving section 69 are fixed to the fixing plate portions 68a.

The upward/downward moving section 69 includes two upward/downward guide mechanisms (guide mechanisms) 71a and 71b supporting the frame body 68 such that the frame body 68 slides (moves upward and downward) relative to the coupling frame 35 in the vertical direction (the Z-axis direction), an upward/downward drive mechanism (a drive mechanism) 72 located between the two upward/downward guide mechanisms 71a and 71b and moves the frame body 68 vertically, an upward/downward drive motor 99 (a DC motor) for driving the upward/downward drive mechanism 72, and a rotary encoder 100 (see FIG. 8) for detecting a rotational displacement amount of the upward/downward drive motor 99.

Each of the upward/downward guide mechanisms 71a and 71b is an LM Guide mechanism (a linear guide mechanism) including an upward/downward guide rail (a guide rail) 74 fixed to the fixing plate portion 68a and at least one upward/downward slider (a slider) 75 fixed to the coupling frame 35. One of the upward/downward guide mechanisms (i.e., a first guide mechanism: hereinafter referred to as a first upward/downward guide mechanism) 71a in the Y-axis direction includes two upward/downward sliders 75, whereas the other upward/downward guide mechanism (i.e., second guide mechanism: hereinafter referred to as a second upward/downward guide mechanism) 71b in the Y-axis direction includes only one upward/downward slider 75. Reference numerals 79 and 80 respectively denote a first coupling member and a second coupling member coupling the upward/downward sliders 75 and the coupling frame 35 together.

The upward/downward drive mechanism 72 includes a ball screw mechanism (a lead screw mechanism) including an upward/downward nut (a movable member) 76 fixed to the fixing plate portion 68a and an upward/downward threaded shaft (a fixed member) 77 fixed to the coupling frame 35. Driving (rotation) of the upward/downward threaded shaft 77 by the upward/downward drive motor 99 causes the upward/downward nut 76 to move vertically relative to the upward/downward threaded shaft 77. With this relative movement, the fixing plate portion 68a moves vertically, and the upward/downward guide rail 74 fixed to the fixing plate portion 68a moves vertically relative to the upward/downward slider 25. In this embodiment, the upward/downward nut 76 is fixed and the upward/downward threaded shaft 77 is rotated so that the upward/downward nut 76 moves vertically relative to the upward/downward guide rail 74. Alternatively, the upward/downward threaded shaft 77 may be fixed with the upward/downward nut 76 being rotated so that the upward/downward nut 76 moves vertically relative to the upward/downward guide rail 74.

In this embodiment, in the upward/downward drive mechanism 72 and the Y-axis moving mechanism 87, the rotation side and the fixed side are reversed for the nuts (the upward/downward nut 76 and the Y-axis nut 98) and the threaded shafts (the upward/downward threaded shaft 77 and the Y-axis threaded shaft 96), but may be the same for the nuts and the threaded shafts. Specifically, a pattern (this embodiment) in which the upward/downward threaded shaft 77 and the Y-axis nut 98 are rotation sides and the upward/downward nut 76 and the Y-axis threaded shaft 96 are fixed sides, a pattern in which the upward/downward nut 76 and the Y-axis threaded shaft 96 are rotation sides and the upward/downward threaded shaft 77 and the Y-axis nut 98 are fixed sides, a pattern in which the upward/downward threaded shaft 77 and the Y-axis threaded shaft 96 are rotation sides and the upward/downward nut 76 and the Y-axis nut 98 are fixed sides, and a pattern in which the upward/downward nut 76 and the Y-axis nut 98 are rotation sides and the upward/downward threaded shaft 77 and the Y-axis threaded shaft 96 are fixed sides, may be employed.

Referring now to FIG. 7, the positional relationship between the first and second upward/downward guide mechanisms 71a and 71b and the upward/downward drive mechanism 72 will be described. As illustrated in FIG. 7, the upward/downward drive mechanism 72 overlaps an XZ plane passing through the barycenter of the recording processor 12 in the Y-axis direction. The upward/downward drive mechanism 72 is located between the first upward/downward guide mechanism 71a and the second upward/downward guide mechanism 71b in the Y-axis direction. The first upward/downward guide mechanism 71a and the second upward/downward guide mechanism 71b are located at one side and the other side, respectively, in the Y-axis direction of the upward/downward threaded shaft 77 and are separated from each other. The first upward/downward guide mechanism 71a, the second upward/downward guide mechanism 71b, and the upward/downward drive mechanism 72 are arranged side by side in the Y-axis direction. The distance L1 between the first upward/downward guide mechanism 71a and the upward/downward drive mechanism 72 is smaller than the distance L2 between the second upward/downward guide mechanism 71b and the upward/downward drive mechanism 72 (i.e., L1<L2).

The upward/downward sliders 75 of the upward/downward guide mechanisms 71a and 71b (i.e., the location at which the upward/downward guide rail 74 is in contact with the upward/downward slider 75) are located above the upward/downward nut 76 of the upward/downward drive mechanism 72 (i.e., the location at which the upward/downward nut 76 is in contact with the upward/downward threaded shaft 77) in the vertical direction (i.e., the upright direction). Upward/downward movement changes the positional relationship between the upward/downward nut 76 fixed to the fixing plate portion 68a and each of the upward/downward sliders 75 fixed to the coupling frame 35. The upward/downward nut 76 and the upward/downward sliders 75 are disposed such that the upward/downward sliders 75 are located above the upward/downward nut 76 irrespective of the change in positional relationship caused by the upward/downward movement. Specifically, the movable range of the upward/downward nut 76 relative to the upward/downward threaded shaft 77 and the movable range of each of the upward/downward sliders 75 relative to the upward/downward guide rail 74 are adjusted such that the upward/downward sliders 75 are always located above the upward/downward nut 76.

The upper upward/downward slider 75a in the first upward/downward guide mechanism 71a is disposed such that the distance L3 between the upward/downward slider 75a in the first upward/downward guide mechanism 71a and the upward/downward nut 76 in the vertical direction is larger than the distance L4 between the upward/downward slider 75b in the second upward/downward guide mechanism 71b and the upward/downward nut 76 in the vertical direction (i.e., L3>L4). The upper upward/downward slider 75a at one side in the Y-axis direction of the upward/downward guide mechanism 71a is located such that the angle θ between the YZ plane and the horizontal surface when viewed from the upward/downward nut 76 is always 45° or more, irrespective of the upward/downward position.

FIG. 8 is a control block diagram illustrating a control configuration of the recording device 1. As illustrated in FIG. 8, the control section 14 is connected to the supporting stage 11, the recording processor 12, and the Y-axis moving section 13. The control section 14 receives operation information on user operation from the operation panel 24 and a detection result (a rotational displacement amount) from the rotary encoder 100 of the upward/downward moving section 69. On the other hand, the control section 14 controls the carriage motor 65 of the X-axis moving section 32, the two print heads 52 of the carriage 51, the UV irradiation LEDs 54a of the UV irradiation units 54, the upward/downward drive motor 99 of the upward/downward moving section 69, and the drive motor 88 of the Y-axis moving section 13, and performs recording operation and lifting/lowering (upward/downward) operation.

In the recording operation, the control section 14 intermittently moves the recording processor 12 from the other side to the one side in the Y-axis direction by using the Y-axis moving section 13 (a line feed). Every when the recording processor 12 stops in the intermittent movement in the Y-axis direction, the recording unit 31 is caused to move in the X-axis direction by the X-axis moving section 32, thereby ejecting ink from the print heads 52 (recording). In this manner, a desired image is recorded on the recording medium A. As described above, the direction from the other side to the one side in the Y-axis direction will be hereinafter referred to as a recording direction in which recording is performed.

In this embodiment, when recording is instructed from the operation panel 24, inspection operation is performed before recording operation. Specifically, the user places the recording medium A on the supporting stage 11 with the recording processor 12 being disposed at one side in the Y-axis direction (at the standby position in placing the recording medium A). Then, with the recording medium A being placed (supported) on the supporting stage 11, the user instructs recording with the operation panel 24. In response to the recording instruction, the control section 14 moves the recording processor 12 to the other side in the Y-axis direction (toward the operation panel 24) by using the Y-axis moving section 13. At this time, while the recording unit 31 moves from one end to the other in the Y-axis direction, it is detected, by using an obstacle detector (not shown) provided in the recording processor 12, whether an obstacle is in contact with the recording processor 12 or there is a possible obstacle that can come into contact with the recording unit 31. In this manner, inspection operation is performed. The obstacle detector detects whether the recording medium A can come into contact with the recording unit 31 or whether an obstacle that can come into contact with the recording unit 31 is present on the recording medium A or the supporting stage 11.

If an obstacle is detected in the inspection operation, the control section 14 stops movement of the recording processor 12 to the other side in the Y-axis direction, and notifies the user of an error. On the other hand, if no obstacle is detected while the recording processor 12 moves from one side to the other in the Y-axis direction, the control section 14 determines that there is no obstacle, moves the recording processor 12 to a predetermined position at the other side in the Y-axis direction (a recording start position), and temporarily stops the recording processor 12. After this temporary stop, the recording processor 12 moves from the other side in the Y-axis direction (at the recording start position) to the one side in the Y-axis direction, and starts the recording operation.

In the lifting/lowering operation, the control section 14 controls the upward/downward drive motor 99 based on a detection result (a rotational displacement amount) of the rotary encoders 100. Specifically, the control section 14 activates (turns on) the rotary encoders 100, drives the upward/downward drive motors 99 based on detection results of the rotary encoders 100, and lifts and lowers the recording unit 31 such that the gap between the recording unit 31 and the supporting stage 11 (or the recording medium A supported thereon) is a predetermined gap. At this time, the control section 14 continues to determine (monitor) whether the difference in rotational displacement amount obtained from the two rotary encoders 100 exceeds a predetermined threshold value. When the difference in rotational displacement amount exceeds the predetermined threshold value, the control section 14 stops driving of the upward/downward drive motors 99 because of the possibility of damage to a component, and notifies the user of an error.

In the foregoing configuration, the upward/downward guide mechanisms 71a and 71b and the upward/downward drive mechanism 72 are arranged side by side in the Y-axis direction, thereby increasing the rigidity of the upward/downward moving section 69 in the Y-axis direction against an inertial force occurring when the recording processor 12 is intermittently moved. Thus, vibration of the recording processor 12 in the Y-axis direction caused by intermittent movement of the recording processor 12 can be reduced with a simple configuration. As a result, the recording precision of the recording unit 31 can be enhanced. In addition, a short standby time for stopping of vibration can increase a throughput (i.e., capacity per unit time).

In addition, since the upward/downward guide mechanisms 71a and 71b are disposed at the front and rear (both sides) in the Y-axis direction of the upward/downward drive mechanism 72, vibration of the recording processor 12 in the Y-axis direction can further be reduced.

In the foregoing configuration, the contact positions (engagement positions) between the upward/downward sliders 75 and the upward/downward guide rails 74 in the vertical direction are different from the contact position (the engagement position) between the upward/downward nut 76 and the upward/downward threaded shaft 77 in the vertical direction. When the recording processor 12 vibrates, the recording processor 12 sways around the contact position between the upward/downward nut 76 and the upward/downward threaded shaft 77, and at this time, the recording processor 12 pivot obliquely when viewed from the upward/downward slider 75. Thus, a force reducing the sway of the recording processor 12 acts on the upward/downward sliders 75. That is, a rotary force is received by the upward/downward guide mechanisms 71a and 71b (and the fixing plate portion 68a supporting the upward/downward guide mechanisms 71a and 71b) (i.e., the function of bracing is obtained). In this manner, the longitudinal vibration in the Y-axis direction can be further reduced.

In addition, at least one of the upward/downward sliders 75 of the upward/downward guide mechanisms 71a and 71b is disposed to form an angle of 45° or more with the upward/downward nut 76. In this configuration, a rotary force applied to the recording unit 31 is firmly received by the upward/downward guide mechanisms 71a and 71b. In this manner, a sufficient rigidity with respect to a load weight can be obtained. The angle is not limited to 45° or more as long as a sufficient rigidity with respect to a load weight is obtained.

The number of upward/downward sliders 75, the distances L1 and L2 to the upward/downward drive mechanism 72, and the distances L3 and L4 of positional shift from the upward/downward sliders 75 described above allow a front portion in the recording direction to be more firmly fixed than a rear portion in the recording direction, thereby reducing an initial sway caused by an inertial force when movement in the recording direction stops. In this manner, vibration can be reduced as a whole, and thus, vibration in the Y-axis direction can further be reduced.

The two upward/downward moving sections 69 apart from each other in the X-axis direction can reduce vibration in the X-axis direction caused by movement of the print heads 52 in the X-axis direction with a simple configuration.

In addition, in the lifting/lowering operation, stop of driving and error detection are performed when the difference between rotational displacement amounts output from the two rotary encoders 100 exceeds a predetermined threshold value, it is possible to prevent the recording processor 12 from being tilted over an allowable range in the lateral direction due to the difference in travel distance between the left and right upward/downward moving sections 69 caused by the lifting/lowering operation. In particular, the difference in travel distance (e.g., in which the distributed load of the right portion including the tank unit 42 is large in this embodiment) occurs between the left and right upward/downward moving sections 69 due to the difference in distributed load between the left portion and the right portion in the recording processor 12 in some cases. The above-described configuration can cope with this difference in a preferable manner.

In this embodiment, the two upward/downward guide mechanisms 71a and 71b are provided. Alternatively, only one of the upward/downward guide mechanisms 71a and 71b may be provided or three or more upward/downward guide mechanisms 71a and 71b may be provided as long as the upward/downward guide mechanisms 71a and 71b and the upward/downward drive mechanism 72 are arranged side by side in the Y-axis direction.

In this embodiment, the ball screw mechanism is employed as the upward/downward drive mechanism 72. However, the invention is not limited to the ball screw mechanism. For example, a drive mechanism using a cam, a drive mechanism using a timing belt, or a drive mechanism using a rack and a pinion may be employed as the upward/downward drive mechanism 72.

In this embodiment, the upward/downward sliders 75 are always located above the upward/downward nuts 76. However, the invention is not limited to this configuration as long as the upward/downward sliders 75 are located above the upward/downward nuts 76 at least while the recording unit 31 performs recording on the recording medium A. Specifically, in operations except the recording operation (i.e., inspection operation or replacement of recording media A), the above-described configuration may be modified such that at least one of three upward/downward sliders 75 is located at the same position as the upward/downward nut 76 and each of the upward/downward sliders 75 is located above the upward/downward nuts 76 during the recording operation.

In addition, in this embodiment, the upward/downward sliders 75 shift upward from the upward/downward nuts 76. Alternatively, the upward/downward sliders 75 may shift downward from the upward/downward nut 76. Further, one or more of the three upward/downward sliders 75 may shift upward from the upward/downward nut 76 with the other upward/downward slider(s) 75 shifting downward from the upward/downward nut 76. In these cases, the distance L3 between at least one of the upward/downward sliders 75 in the first upward/downward guide mechanism 71a and the upward/downward nut 76 in the vertical direction is larger than the distance L4 between the upward/downward slider 75b in the second upward/downward guide mechanism 71b and the upward/downward nut 76 in the vertical direction.

In this embodiment, the distance L1 between the first upward/downward guide mechanism 71a and the upward/downward drive mechanism 72 is always smaller than the distance L2 between the second upward/downward guide mechanism 71b and the upward/downward drive mechanism 72. However, the invention is not limited to this configuration as long as the distance L1 between the first upward/downward guide mechanism 71a and the upward/downward drive mechanism 72 is smaller than the distance L2 between the second upward/downward guide mechanism 71b and the upward/downward drive mechanism 72 at least while the recording unit 31 performs recording on the recording medium A.

In this embodiment, the distance L3 between the upward/downward nut 76 of at least one of the upward/downward sliders 75a of the first upward/downward guide mechanism 71a in the vertical direction is always larger than the distance L4 between the upward/downward nut 76 of the upward/downward slider 75b of the second upward/downward guide mechanism 71b in the vertical direction. However, the invention is not limited to this configuration as long as the distance L3 between the upward/downward nut 76 of at least one of the upward/downward sliders 75a of the first upward/downward guide mechanism 71a in the vertical direction is larger than the distance L4 between the upward/downward nut 76 of the upward/downward slider 75b of the second upward/downward guide mechanism 71b in the vertical direction at least while the recording unit 31 performs recording on the recording medium A.

In this embodiment, the invention is applied to the recording device 1 that performs recording with the recording unit 31 moving in the X-axis and Y-axis directions. The invention is also applicable to a recording device 1 (a so-called line printer) that performs recording with a recording unit 31 including a line scan head moving only in the Y-axis direction.

In this embodiment, the X-axis direction is a so-called main scanning direction, and the Y-axis direction is a so-called sub-scanning direction.

The entire disclosure of Japanese Patent Application No. 2013-054688, filed Mar. 18, 2013 is expressly incorporated by reference herein.

What is claimed is:

1. A recording device comprising:
a stage configured to support a recording medium;
a recording unit configured to perform recording on the supported recording medium;
a first moving section configured to move the recording unit in a first direction; and
a second moving section configured to move the recording unit in a second direction intersecting the first direction such that the recording unit moves toward and away from the stage, wherein
the second moving section includes
a drive mechanism configured to move the recording unit toward and away from the stage, and
a guide mechanism configured to guide the movement of the recording unit in the second direction, and
the drive mechanism and the guide mechanism are disposed side by side in the first direction.

2. The recording device according to claim 1, wherein
the guide mechanism includes a linear guide mechanism including a guide rail and a slider that is movable relative to the guide rail in the second direction,
the drive mechanism includes a fixed member and a movable member that is movable relative to the fixed member, and
at least while the recording unit performs recording on the recording medium, a contact position at which the slider is in contact with the guide rail in the second direction is different from a contact position at which the fixed member is in contact with the movable member in the second direction.

3. The recording device according to claim 2, wherein
the guide mechanism has a first guide mechanism located forward of the drive mechanism in a recording direction in which the recording unit performs recording and which is either a forward direction or a backward direction of the recording unit in the first direction.

4. The recording device according to claim 3, wherein
the guide mechanism includes a second guide mechanism located backward of the drive mechanism in the recording direction.

5. The recording device according to claim 4, wherein
at least while the recording unit performs recording on the recording medium, a contact position in the first guide mechanism at which the slider is in contact with the guide rail in the second direction is located farther from the drive mechanism than a contact position in the second guide mechanism at which the slider is in contact with the guide rail in the second direction is.

6. The recording device according to claim 4, wherein
the first guide mechanism includes a larger number of sliders than the second guide mechanism does.

7. The recording device according to claim 4, wherein
a distance between the first guide mechanism and the drive mechanism in the first direction is smaller than a distance between the second guide mechanism and the drive mechanism in the first direction.
